(19) United States
(12) Patent Application Publication
(10) Pub. No.: US 2009/0153054 A1
(43) Pub. Date: Jun. 18, 2009

(54) ELECTRIC DISCHARGE LAMP

(75) Inventors: Bart Theresia Verlinden, Turnhout (BE); Gerald Frederik Belder, Eindhoven (NL); Mark Bolech, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,442

(22) PCT Filed: Aug. 10, 2005
(86) PCT No.: PCT/IB2005/052652

§ 371 Date: Feb. 11, 2008

(51) Int. Cl. H01J 61/20

(52) U.S. Cl. 313/639

(57) ABSTRACT

An electric discharge lamp comprising: a light-transmissive ceramic lamp vessel; a first and a second current conductor each supporting an electrode in the lamp vessel; an ionizable filling comprising a noble gas and metal halide in the lamp vessel; at least the first current conductor being halide-resistant characterized in that the first current conductor forms an end wall of the lamp vessel, wherein the difference between the coefficient ai of linear thermal expansion of said end wall and the coefficient a2 of linear thermal expansion of the lamp vessel is equal to or less than 2.10-6 K¹; or the first current conductor is at least partially provided at its outer surface with a halide-resistant layer, wherein the difference between the coefficient a₁ of linear thermal expansion of said first current conductor and the coefficient a₂ of linear thermal expansion of the lamp vessel is equal to or less than 2.10-6 K⁻¹, and wherein said first current conductor is made of a metal, particularly a metal selected from the group consisting of titanium, palladium, platinum, vanadium, lutetium and rhodium, or an alloy thereof.

The present invention relates to an electric discharge lamp comprising:

a light-transmissive ceramic lamp vessel;

a first and a second current conductor each supporting an electrode in the lamp vessel;

an ionizable filling comprising a noble gas and metal halide in the lamp vessel;

at least the first current conductor being halide-resistant.

Such an electric lamp is known from EP-A-0 587 238. This known lamp is equipped with a ceramic sealing compound, whereas the ionizable filling comprises mercury. The current conductor of such a lamp must have a linear coefficient of thermal expansion, which corresponds to that of the lamp vessel in order to prevent leakage of the lamp. Leakage may even occur in the manufacturing of the lamp when the lamp cools down after the sealing compound has been provided at a relatively high temperature. At a too small coefficient of expansion of the current conductor, the lamp vessel shrinks to a stronger extent and it may crack or even break. At a too large coefficient of expansion, leakage may occur around the current conductors. However, the current conductors must also be resistant to the ionizable filling of the lamp, particularly to halide, at least in so far as they are in contact therewith: they should at least not substantially be attacked by or react with halide or halogen formed therefrom. A low resistance may not only result in damage and destruction of the current conductor but also in a loss of halide in the filling and in a color change of the light generated by the lamp. Moreover, the current conductors must withstand the thermal manufacturing and operating conditions of the lamp and, to limit electrical losses, they should be good conductors. Since the requirements imposed on expansion and chemical resistance are often not combined in one material, at least the first current conductor of the known lamp within the lamp vessel has an inner halide-resistant part having a different expansion than the lamp vessel, and an outer part which extends from the seal and is not halide-resistant but has a corresponding expansion. This part often consists of niobium, tantalum or an alloy thereof, metals which, due to their oxidation sensitivity at higher temperatures, should be screened from air by using an outer envelope for the lamp. If the lamp vessel is relatively narrow and elongate, and if it has a vertical operating position, the halogen formed from the halide is particularly present in the upper portion of the lamp vessel. It is then sufficient when only the first current conductor has an inner halide-resistant portion and is present in the upper part of the lamp vessel. However, the lamp can then not be operated upside down, horizontally or obliquely. However, for obtaining a universal operating position, the lamp can be given a second current conductor corresponding to the first. The inner part of the current conductors of the known lamp generally comprises a molybdenum coil or a cermet of molybdenum and aluminum oxide.

It is a drawback of the known lamp that the sealing compound sealing the ceramic lamp vessel around the current conductors is sensitive to high (operating) temperatures of the lamp. Therefore, it is necessary in the known lamp to apply the sealing compound as remote as possible from the central part of the lamp vessel, i.e. at an outer end of extended plugs (i.e. elongated parts) that are connected by way of sintering to the central part of the lamp vessel. Consequently, the construction of the known lamp is not as compact as desirable. Further, the use of said extended plugs is undesirable from a technical point of view: said plugs function as cooling fins negatively influencing the efficacy of the lamp, whereas capillaries are introduced in said extended plugs. Part of the lamp filling, particularly molten salts, may condense in a so-called dead volume in said extended plugs at the location of the capillaries leading to color instability of the lamp. In the known lamp an excess of such (expensive) salts needs to be dosed to compensate the loss of part of the salts in said dead volume.

It is an object of the present invention to obviate these disadvantages and in order to accomplish that objective an electric lamp of the type referred to in the introduction according to the invention is characterized in that the first current conductor forms an end wall of the lamp vessel, wherein the difference between the coefficient α₁ of linear thermal expansion of said end wall and the coefficient α₂ of linear thermal expansion of the lamp vessel is equal to or less than 2.10-6 K⁻¹. By forming the first current conductor as an end wall (also called “end cap”) of the lamp vessel a very compact lamp construction is obtained. Further, research has revealed that thermal stresses in the material of the first current conductor can be prevented if the end cap has a coefficient α₁ of linear thermal expansion that is to a very large extent similar to the coefficient α₂ of linear thermal expansion of the ceramic lamp vessel.

In one preferred embodiment of an electric discharge lamp in accordance with the invention said end wall comprises a first layer and a halide-resistant, second layer on a side of said first layer facing the lamp vessel. Particularly, said end wall comprises a sandwich construction of a middle first layer and halide-resistant outer second layers. This embodiment is based on the awareness that the materials in the sandwich construction actively compensate mutually differing coefficients of linear thermal expansion in such a manner that the resulting average coefficient of thermal expansion shows a deviation compared to the coefficient of thermal expansion of the ceramic lamp vessel (for example, Al₂O₃) of less than 2.10-6 K⁻¹.

In another preferred embodiment of an electric discharge lamp according to the invention said first layer is made of a metal, particularly a metal selected from the group consisting of titanium, niobium, palladium, vanadium, rhodium, lutetium and platinum, or an alloy thereof. Said halide-resistant layer is preferably made of molybdenum, tungsten or rhenium, or an alloy thereof. Experiments have shown that combinations of titanium and molybdenum or vanadium and molybdenum are very advantageous.

On order to obviate the disadvantages of the prior art the invention also relates to an electric discharge lamp comprising:

a light-transmissive ceramic lamp vessel;

a first and a second current conductor each supporting an electrode in the lamp vessel;

an ionizable filling comprising a noble gas and metal halide in the lamp vessel;

at least the first current conductor being halide-resistant characterized in that the first current conductor is at least partially provided at its outer surface with a halide-resistant layer, wherein the difference between the coefficient α₁ of linear thermal expansion of said first current conductor and the coefficient α₂ of linear thermal expansion of the lamp vessel is equal to or less than 2.10-6 K⁻¹, and wherein said first current conductor is made of a metal, particularly a metal selected from the group consisting of titanium, palladium, vanadium, rhodium, lutetium and platinum, or an alloy thereof. Particularly, said halide-resistant layer is made of molybdenum, tungsten or rhenium, or an alloy thereof.

Advantageously, said halide-resistant layer is formed as an halide-resistant cup made of molybdenum, tungsten or rhenium, or an alloy thereof, wherein said cup is filled with a material joined to the inner wall of the cup. Said material is platinum, palladium, rhodium, lutetium, litanium, vanadium, or an alloy thereof and compensates the thermal expansion of the cup in such a manner that the coefficient α₁ of linear thermal expansion of the cup filled with said material differs less than 2.10-6K⁻¹ from the coefficient α₂ of linear thermal expansion of the lamp vessel.

In another preferred embodiment of an electric discharge lamp according to the invention the thickness of said halide-resistant layer is at least 50 μm. In another preferred embodiment the first current conductor is provided with a halide-resistant layer along at least 4 mm of its length.

The invention will now be explained in more detail with reference to three figures illustrated in a drawing, wherein

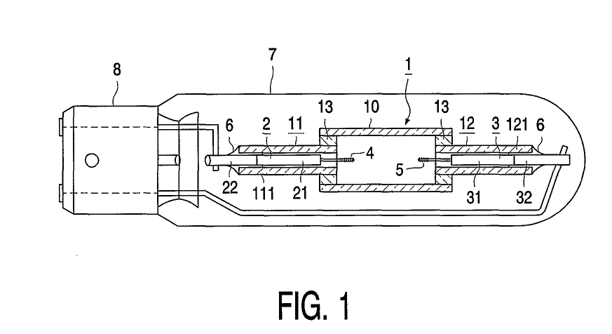

FIG. 1 shows a prior art electric discharge lamp in a side elevation, partly in cross-section; and

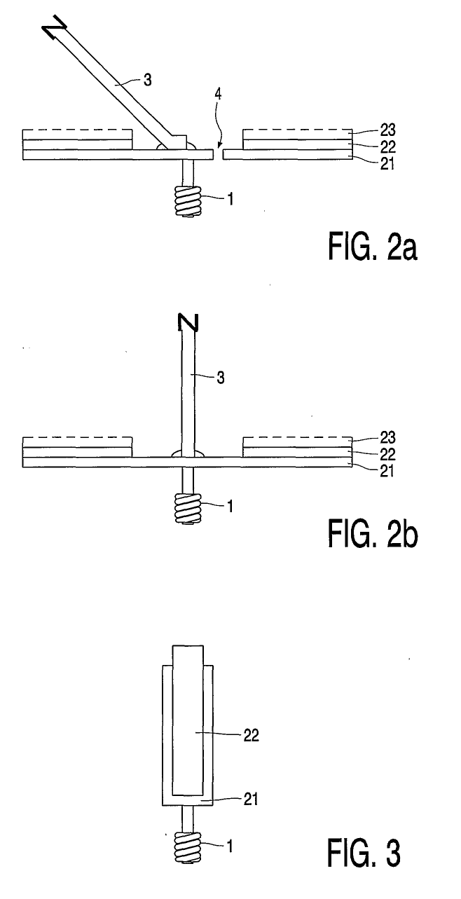

FIGS. 2a, 2b and 3 schematically show different embodiments of one end of an electric discharge lamp in accordance with the invention in cross-section.

FIG. 1 shows an electric discharge lamp in accordance with the invention provided with a tubular, light-transmissive, ceramic lamp vessel 1 made from polycrystalline aluminum oxide, with a first and a second current conductor 2,3. Said conductors 2,3 enter the lamp vessel 1 opposite each other and each support a tungsten electrode 4,5 present in the lamp vessel 1 and welded to the current conductors 2,3. A ceramic sealing compound 6 formed in a melting process by 30% by weight of aluminum oxide, 40% by weight of silicon oxide and 30% by weight of dysprosium oxide, seals the current conductors 2,3 in a gastight manner. The lamp vessel 1 has an ionizable filling comprising argon as a rare gas and a mixture of sodium, thallium and dysprosium iodide as metal halides. Both the first and the second current conductor 2,3 each have a first halide-resistant part 21,31 within the lamp vessel 1 and, extending from the ceramic sealing compound 6 to the exterior of the lamp vessel 1, a second part 22,32 welded to the first part 21,31. The second part 22,32 of the current conductors 2,3 consists of niobium and is entirely incorporated in the ceramic sealing compound 6 within the lamp vessel 1. In an alternative embodiment both current conductors 2,3 are each made in one piece of one material.

The lamp vessel 1 has narrow end parts or extended plugs 11,12 in which a respective current conductor 2,3 is enclosed. The plugs 11,12 have a free end 111,121, where the lamp vessel 1 is sealed by the ceramic sealing compound 6. The central part 10 of the lamp vessel 1 is connected by way of sintering to the plugs 11,12 via ceramic discs 13. The lamp vessel 1 is enveloped by an outer envelope 7 sealed in a gastight manner and evacuated or filled with an inert gas in order to protect the niobium second parts 22,32 of the current conductors 2,3. The outer envelope 7 supports a lamp cap 8.

FIGS. 2a and 2b schematically show one end of a tubular, light-transmissive, ceramic lamp vessel 1 in accordance with a preferred embodiment of the invention, wherein a very compact lamp construction is realized. FIGS. 2a and 2b schematically show 2 variations of a preferred embodiment of the invention, which can be joined directly to the outer end of the ceramic lamp vessel (the tube 1 in FIG. 1), thus obviating the discs and plugs (the parts 13, 11 and 12 in FIG. 1)

The tungsten electrode 1 is joined (preferably welded) to the halide resistant part 21 of the end cap assembly. This end cap assembly consists of the halide resistant layer 21, the compensation layer 22 preferably annular) and optionally a second layer 23 (preferably annular). The halide resistant layer 21 is made of molybdenum, rhenium, tungsten or an alloy thereof, and has a linear thermal expansion, which is considerably lower than that of the vessel material. The compensation layer 22 is made of platinum, palladium, rhodium, lutetium, titanium, vanadium or an alloy thereof, and has a linear thermal expansion higher than that of the vessel material. The optional layer 23 is made of the same material as layer 21. In this sandwich construction the layer 22 compensates the low linear thermal expansion of layer 21 (and 23, if present) in such a manner that the resulting coefficient of linear thermal expansion of the cap assembly differs less than 2.10-6 K⁻¹ from the coefficient of linear thermal expansion of the vessel material. Application of an extra layer 23 has the advantage that warping of the assembly is largely suppressed.

In order to connect the vessel to the electrical supply wires, a lead out wire 3 is joined (preferably welded) to the layer 21. Filling of the lamp vessel can be done via an off-center filling hole 4, which is closed (e.g. by welding or brazing) after filling (FIG. 2a). Alternatively, this filling hole is omitted and filling is performed through a central hole in layer 21, which is subsequently closed by inserting the electrode 1 and lead out wire 3 and creating a gastight joint to layer 21 (FIG. 2b)

The end cap as depicted in FIGS. 2a and 2b may be used at one or both ends of the lamp vessel.

FIG. 3 shows another preferred embodiment of the invention. This embodiment obviates the need for plugs (11 and 12 in FIG. 1) and can be directly inserted to the discs (13 in FIG. 1) and sealed.

The tungsten electrode 1 is joined (preferably welded) to the bottom of the halide resistant cup 21 of the feedthrough assembly. This assembly consists of the halide resistant cup 21 and the compensation rod 22, which is joined seamlessly to the inner wall of the cup. The halide resistant part 21 is made of molybdenum, rhenium, tungsten or an alloy thereof, and has a linear thermal expansion, which is considerably lower than that of the vessel material. The compensation rod 22 is made of platinum, palladium, rhodium, lutetium, titanium, vanadium or an alloy thereof, and has a linear thermal expansion higher than that of the vessel material. In this feedthrough assembly the compensation rod 22 compensates the low linear expansion of the cup 21 in such a manner that the resulting coefficient of linear thermal expansion of the feedthrough assembly differs less than 2.10-6 K⁻¹ from the coefficient of linear thermal expansion of the vessel material.

The thickness of the sidewall of cup 21 is at least 50 μm, whereas the compensation rod is present along a length of at least 4 mm, measured from the bottom of the cup.

The feedthrough construction as depicted in FIG. 3 may be used at one or both ends of the lamp vessel.

The invention is not restricted to the variants shown in the drawing, but it also extends to other embodiments that fall within the scope of the appended claims.

1. An electric discharge lamp comprising:
a light-transmissive ceramic lamp vessel;
a first and a second current conductor each supporting an electrode in the lamp vessel;
an ionizable filling comprising a noble gas and metal halide in the lamp vessel;
at least the first current conductor being halide-resistant characterized in that the first current conductor forms an end wall of the lamp vessel, wherein the difference between the coefficient α₁ of linear thermal expansion of said end wall and the coefficient α₂ of linear thermal expansion of the lamp vessel is equal to or less than 2.10-6 K⁻¹.

2. An electric discharge lamp according to claim 1, wherein said end wall comprises a first layer and a halide-resistant, second layer on a side of said first layer facing the lamp vessel.

3. An electric discharge lamp according to claim 1, wherein said end wall comprises a sandwich construction of a middle first layer and halide-resistant, outer second layers.

4. An electric discharge lamp according to claim 2, wherein said first layer is made of a metal, particularly a metal selected from the group consisting of titanium, niobium, palladium, platinum, vanadium, lutetium and rhodium, or an alloy thereof.

5. An electric discharge lamp according to claim 2, wherein said halide-resistant layer is made of molybdenum, tungsten or rhenium, or an alloy thereof.

6. An electric discharge lamp comprising:
a light-transmissive ceramic lamp vessel;
a first and a second current conductor each supporting an electrode in the lamp vessel;
an ionizable filling comprising a noble gas and metal halide in the lamp vessel;
at least the first current conductor being halide-resistant characterized in that the first current conductor is at least partially provided at its outer surface with a halide-resistant layer, wherein the difference between the coefficient α₁ of linear thermal expansion of said first current conductor and the coefficient α₂ of linear thermal expansion of the lamp vessel is equal to or less than 2.10-6 K⁻¹, and wherein said first current conductor is made of a metal or an alloy thereof, particularly a metal selected from the group consisting of titanium, palladium, platinum, vanadium, lutetium and rhodium.

7. An electric discharge lamp according to claim 6, wherein said halide-resistant layer is made of molybdenum, tungsten or rhenium, or an alloy thereof.

8. An electric discharge lamp according to claim 6, wherein the thickness of said halide-resistant layer is at least 50 μm.

9. An electric discharge lamp according to claim 6, wherein the first current conductor is provided with a halide-resistant layer along at least 4 mm of its length.
